(19) United States
(12) Patent Application Publication
(10) Pub. No.: US 2018/0367505 A1
(43) Pub. Date: Dec. 20, 2018

(54) System and Method for Automated Real Time Information and Data Collection

(71) Applicant: Samuel Logan, Philadelphia, PA (US)

(72) Inventor: Samuel Logan, Philadelphia, PA (US)

(21) Appl. No.: 16/013,591

(22) Filed: Jun. 20, 2018

Related U.S. Application Data
(60) Provisional application No. 62/522,599, filed on Jun. 20, 2017.

(51) Int. Cl. H04L 29/06; G06F 17/30; G07C 13/00; G06Q 30/06; H04L 12/58

(52) U.S. Cl. CPC H04L 63/0421; G06F 17/30283; H04L 51/04; G06Q 30/0637; G07C 13/00

(57) ABSTRACT

Entities are connected directly with screened, trained, and professional local providers, thereby creating a global network of offline data collectors. Technology is leveraged to facilitate direct access for a user entity to a global network of local suppliers that may be recruited, trained, and oriented toward collecting offline information. A central server provides a one-stop solution to fully understand what data or documents are publicly available in global jurisdictions. Products may be made available by the central server and organized by city or country cards, thereby providing a menu of available data or documents.

### PRIORITY

This application claims priority to U.S. Provisional 62/522,599, filed Jun. 20, 2017, which is hereby incorporated by reference as if submitted in its entirety.

### FIELD OF THE INVENTION

The present invention relates to automated and real-time gathering and reporting of information from remote location to at least one requester.

### BACKGROUND

Today, a significant amount of information can be found online, but there will always be a distance between what can be found online and what can be obtained from localized contacts. This distance is what is called the last mile of data collection. Valuable data required by companies and funds engaged in risk mitigation exercises, such as due diligence investigations, is normally deposited in offline archives that are difficult to access. Currently, there is a worldwide service and consulting industry in place to assist with access to offline archives as part of a general offering, from large accounting firms and law firms to professional service firms and sole proprietors. These suppliers rely on personal networks of local individuals who they leverage to access the data, often times through several layers of middlemen. This process creates inefficiencies in time, price, and communication.

### BRIEF SUMMARY OF THE INVENTION

The present disclosure is directed towards a system and method of connecting entities directly with screened, trained, and professional local providers, thereby creating a global network of offline data collectors. Technology is leveraged to facilitate direct access for a user entity to a global network of local suppliers that may be recruited, trained, and oriented toward collecting offline information. A central server provides a one-stop solution to fully understand what data or documents are publicly available in global jurisdictions. Products may be made available by the central server and organized by city or country cards, thereby providing a menu of available data or documents. City/country cards and menus may be provided by a web application, for example. The central server may also locally record data retrieval operations and other offline retrieval activities, such as site visits. Data communications via the central server may include the utilization of an application programming interface (API) or a mobile application, for example.

### BRIEF DESCRIPTION OF THE DRAWINGS

This disclosure is illustrated by way of example and not by way of limitation in the accompanying figure(s). The figure(s) may, alone or in combination, illustrate one or more embodiments of the disclosure. Elements illustrated in the figure(s) are not necessarily drawn to scale. Reference labels may be repeated among the figures to indicate corresponding or analogous elements.

The detailed description makes reference to the accompanying figures in which:

FIG. 1 illustrates an exemplary computing environment of at least one embodiment of the disclosed invention;

FIG. 2 illustrates an exemplary function block diagram of computing system 200 in accordance with at least one embodiment of the disclosed invention;

FIGS. 3-16 illustrate exemplary interface implementations in accordance with the disclosed invention; and

FIG. 17 illustrates an exemplary workflow diagram in accordance with the disclosed invention.

### DETAILED DESCRIPTION

The figures and descriptions provided herein may have been simplified to illustrate aspects that are relevant for a clear understanding of the herein described apparatuses, systems, and methods, while eliminating, for the purpose of clarity, other aspects that may be found in typical similar devices, systems, and methods. Those of ordinary skill may thus recognize that other elements and/or operations may be desirable and/or necessary to implement the devices, systems, and methods described herein. But because such elements and operations are known in the art, and because they do not facilitate a better understanding of the present disclosure, for the sake of brevity a discussion of such elements and operations may not be provided herein. However, the present disclosure is deemed to nevertheless include all such elements, variations, and modifications to the described aspects that would be known to those of ordinary skill in the art.

Embodiments are provided throughout so that this disclosure is sufficiently thorough and fully conveys the scope of the disclosed embodiments to those who are skilled in the art. Numerous specific details are set forth, such as examples of specific components, devices, and methods, to provide a thorough understanding of embodiments of the present disclosure. Nevertheless, it will be apparent to those skilled in the art that certain specific disclosed details need not be employed, and that exemplary embodiments may be embodied in different forms. As such, the exemplary embodiments should not be construed to limit the scope of the disclosure. As referenced above, in some exemplary embodiments, well-known processes, well-known device structures, and well-known technologies may not be described in detail.

Embodiments set forth herein intend to bring international data seekers, or buyers, as close to a global network of local providers as possible, to the point where direct communication is provided via a secure, anonymous messaging and case management system via a central server. This is achieved through careful curation of data and the development, training, and management of local professionals. Data curation methods set forth herein ensure accurate data is provided from local entities, such as foreign governments at the municipal level, or the like. Local professionals are determined to be trustworthy, responsible, and capable through an extensive on-boarding and compliance process. Information obtained by the central server and provided to entities may include, but certainly is not limited to, individual background checks, corporate registrations, and criminal litigations records, for example. Having leveraged local knowledge enables the creation of country cards as described further below. We ensure that you know what to ask for, and that the local collections professional knows where and how to obtain what you need.

As the marketplace grows, the disclosed server platform may constantly broaden a network of local professionals to meet the needs of international buyers. The server platform locates, tests, checks, and trains these locals for buyers, so they can focus specifically on the data they need, and not worry about whether or not the local professional is trustworthy, responsible, capable, or paid on time.

As this marketplace grows, our expectation is that international buyers will consider the server platform disclosed as the one source they need to obtain data not available online. Further understanding of the disclosed invention may be achieved through the embodiments fully described below.

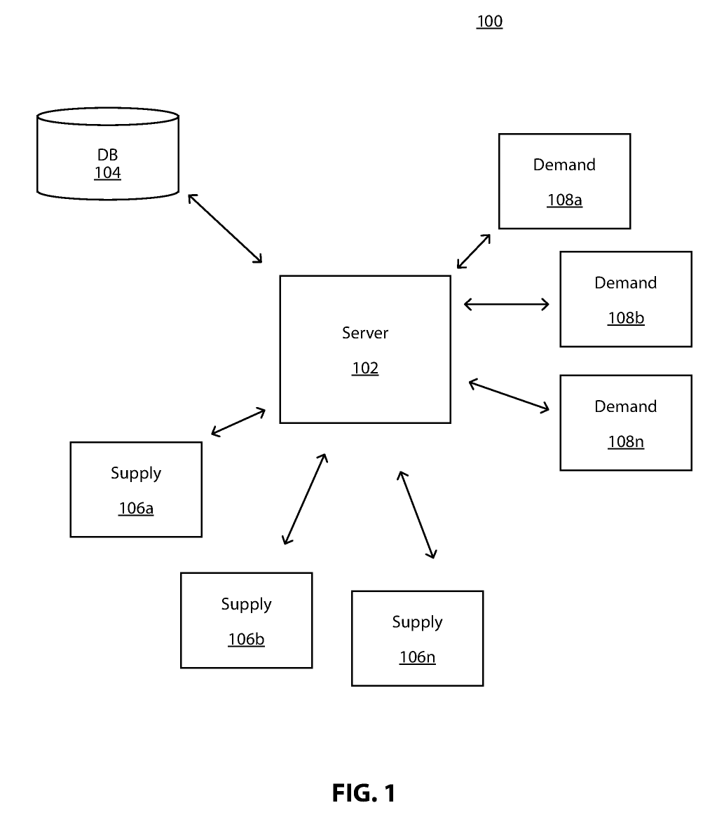

FIG. 1 illustrates a diagram 100 of an exemplary environment of at least one embodiment of the disclosed invention. For example, Server Platform 102 may be a central server that facilitates communications between local providers (e.g., Supply 106a, Supply 106b, . . . Supply 206n) and data requesters (e.g., Demand 108a, Demand 108b, . . . 108n). While a single Server 102 is shown, it is understood that multiple servers may be utilized in conjunction with various hardware elements to a create a single platform. Server 102 may utilize local storage, remote storage, or a combination of local and remote storage options. For example, data records may be securely stored and maintained on Database 104. Suppliers 106a-n may include local citizens or employees of foreign jurisdictions, for example. Demanders 108a-n may include business or corporate entities, accounting firms, local governments, or the like. Server 102, prior to facilitating communications, may properly vet Suppliers 106a-n and Demanders 108a-n. For example, Server 102 may thoroughly investigate Suppliers 106a-n to determine documents available, trustworthiness, and responsibility factors of Suppliers 106a-n. Suppliers 106a-n may be located within localities foreign to Demanders 108a-n. For example, Supply 106a may be a government official located in Barcelona, Spain while Demand 108a may be a user located in Lancaster, Pa., USA. Utilizing the secure and anonymous messaging platform provided by Server 102, business may be facilitated wherein the user can request certain documents (e.g., company registration records, regulatory sanctions, company search report summaries, for example) from the government official. By using Server 102, the user would have confidence that they are being provided with not only the proper document, but also a requested document at a fair price. Use of the service provided by Server 102 may be provided at a certain cost, either per document or on a subscription basis. A subscription may include a discount on every order placed (e.g., 15% oft). As long as the total value of the discount over a calendar year is greater than the annual subscription rate, subscribers should see value. Subscriptions may be tiered for individual user accounts, company accounts (for small- to mid-sized businesses, for example), university accounts, and enterprise accounts (e.g., Fortune 500).

Country, or city, cards are curated by the platform which develop proprietary information that essentially details what is legally and publicly available and therefore aggregated by the server platform. Cards may be categorized. Categories may include, for example, corporate, litigation, assets, and identification and organized for each card. Each category may include several items all codified and detailed so at a glance users, or clients, may know exactly what they will receive, where it will be coming from, what is required to obtain it, and an a la carte price. The supplier and the demander may each be provided with the same city/country card to facilitate “apples to apples” requests. For example, when a demander requests a certain document for Nigeria, for example a company registration document, a local provider in Nigeria (e.g., in Lagos or Abuja) would understand exactly what is being requested. There may be two sets of city/country cards for each country. One for the demander and one for the supplier. The only difference between the two cards provided may be the price indicated by the card. For example, a demander may be shown the price to be paid to obtain the requested document (e.g., price paid to local government and to server platform), while a supplier's card may only see the highest price they will be paid by the server platform to obtain the information.

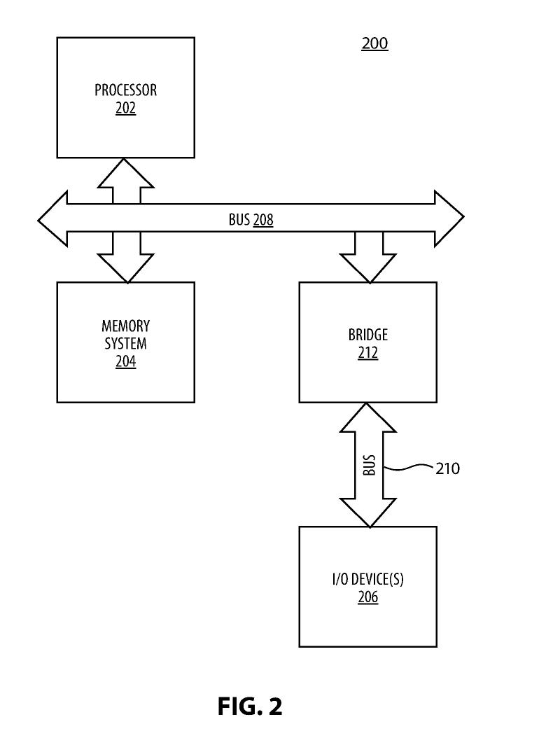

FIG. 2 is an example of a simplified functional block diagram of a computer system 200. The functional descriptions of the present invention can be implemented in hardware, software or some combination thereof.

As shown in FIG. 2, the computer system 200 includes a processor 202, a memory system 204 and one or more input/output (I/O) devices 206 in communication by a communication ‘fabric’. The communication fabric can be implemented in a variety of ways and may include one or more computer buses 208, 210 and/or bridge and/or router devices 212 as shown in FIG. 2. The I/O devices 206 can include network adapters and/or mass storage devices from which the computer system 200 can send and receive data. The computer system 200 may be in communication with the Internet via the I/O devices 208. 20. Those of ordinary skill in the art will recognize that many modifications and variations of the present invention may be implemented without departing from the spirit or scope of the invention. Thus, it is intended that the present invention cover the modification and variations of this invention provided they come within the scope of the appended claims and their equivalents.

The various illustrative logics, logical blocks, modules, and engines, described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of instructions on a machine readable medium and/or computer readable medium.

It is appreciated that exemplary computing system 200 is merely illustrative of a computing environment in which the herein described systems and methods may operate, and thus does not limit the implementation of the herein described systems and methods in computing environments having differing components and configurations. That is, the inventive concepts described herein may be implemented in various computing environments using various components and configurations.

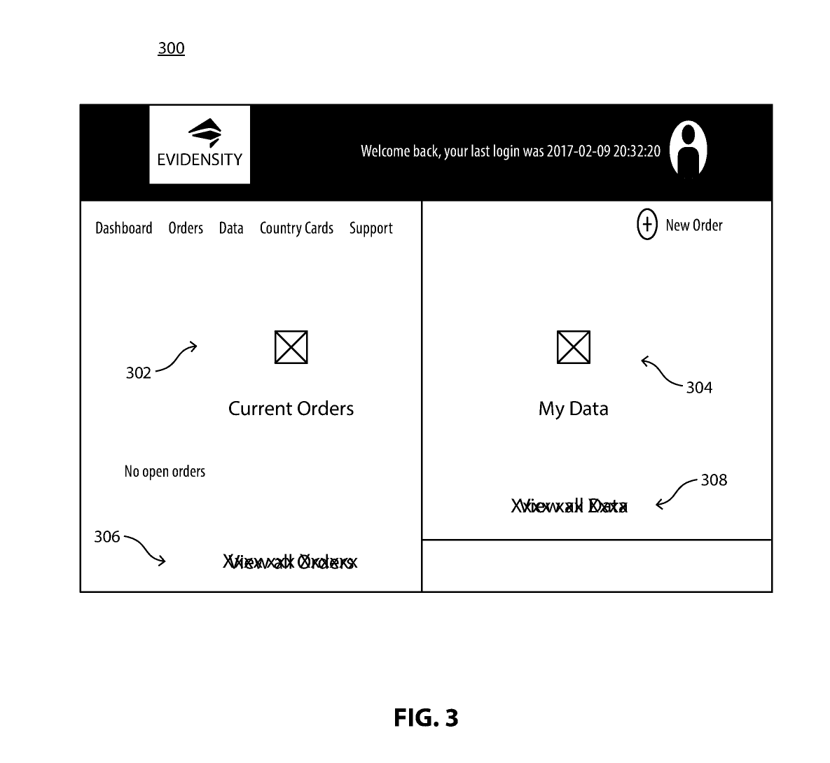

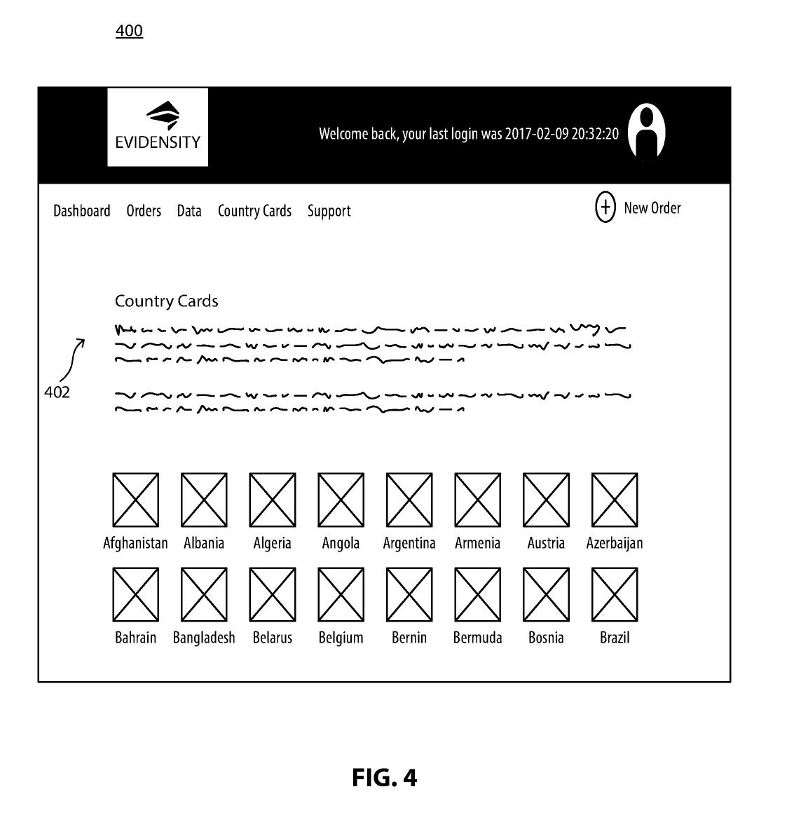

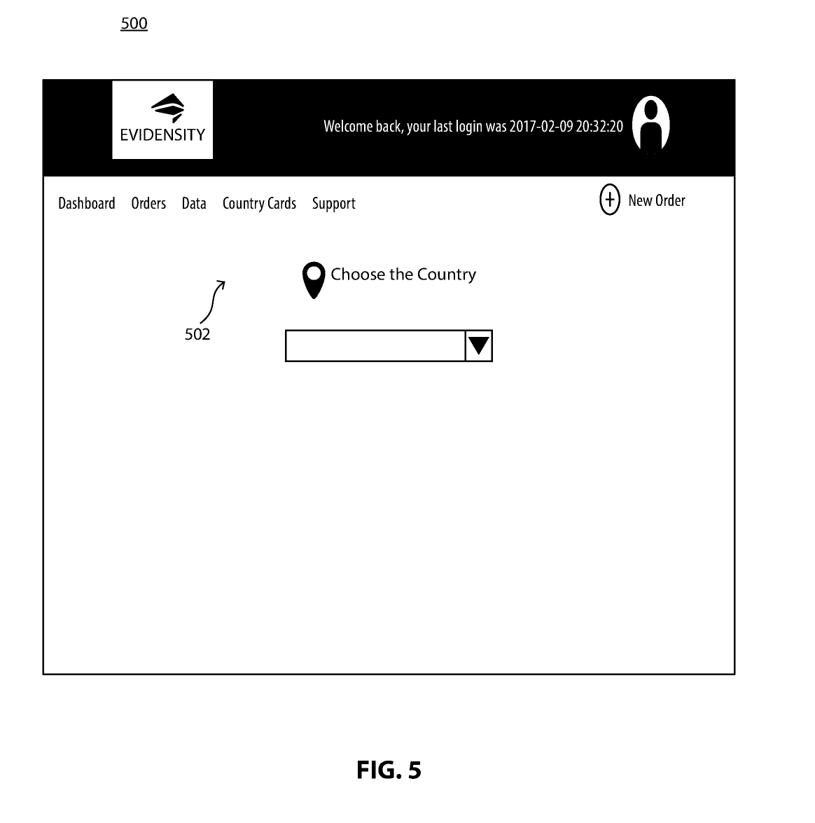

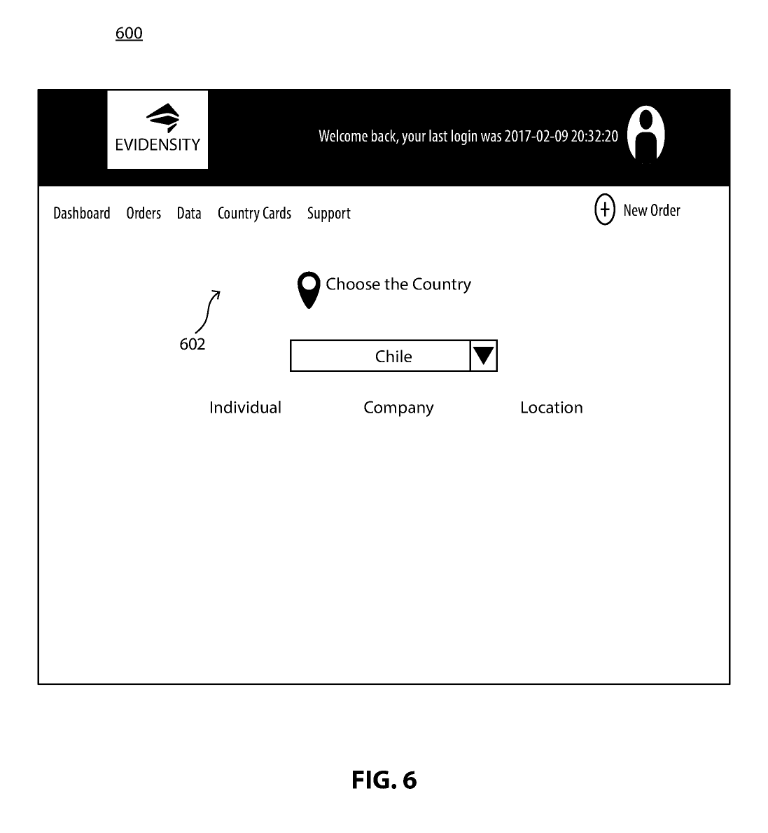

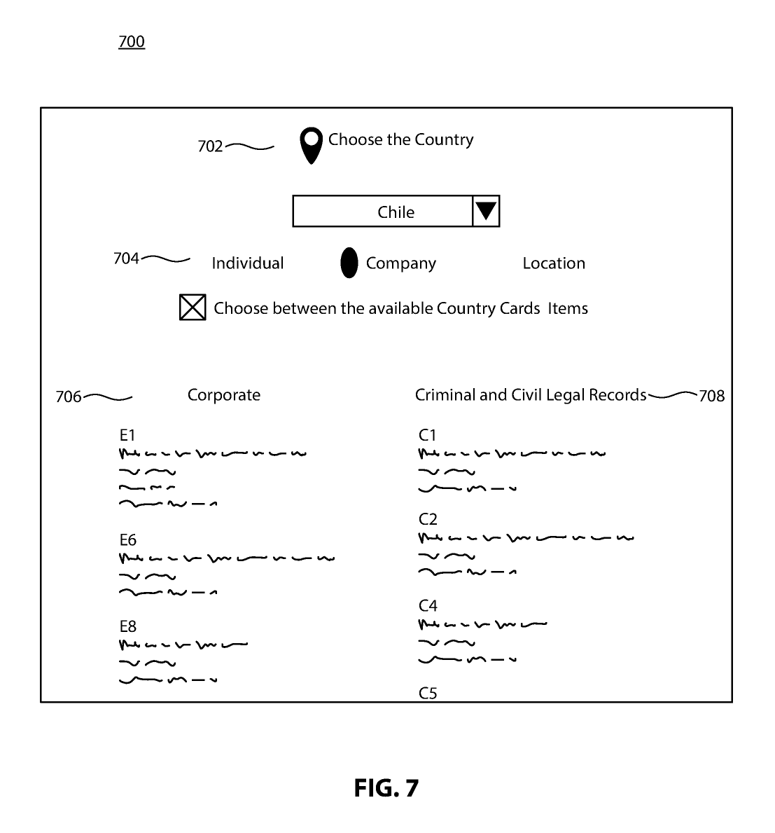

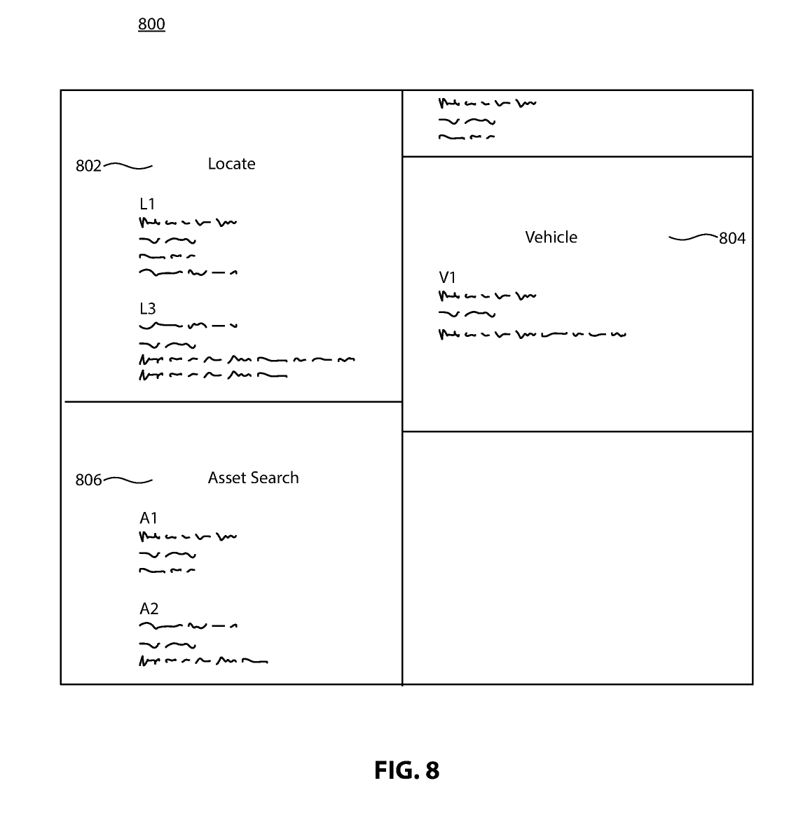

FIGS. 3-18 provide various and exemplary user interfaces in accordance with one or more embodiments of the disclosed invention. For example, FIG. 3 illustrates an exemplary user home screen 300, that may show Current Orders 302, View All Orders 306, My Data 304, and View all Data 308. A user may start a new order by clicking, or tapping, on the +next to New Order. FIG. 4 illustrates an interface 400 showing exemplary country cards (or city cards) 402. Different country cards may be previewed by selecting various countries. The exemplary countries shown are not meant to be limiting in any way. FIG. 5 illustrates another interface 500 implementation where a user may select a country via a drop-down box 502. FIG. 6 illustrates interface 600 where once a country is selected (e.g., Chile), a user via window 602 may select Individual, Company, or Location. As shown in FIG. 7, interface 700, after Choose the Country 702 has been selected, Chile for example, and Company 704 is selected, a user may be shown available products via the country's country card, such as Corporate 706 records and Criminal and Civil Legal Records 708. In at least one embodiment, users of the system may be shown the most recent version of a city/country card. The city/country cards may be updated on a regular basis to include the most up to date information. After selection, and as shown in interface 800 of FIG. 8, a user may be shown additional, or more detailed information, with respect to Location 802, Asset Search 806, and Vehicle information 804.

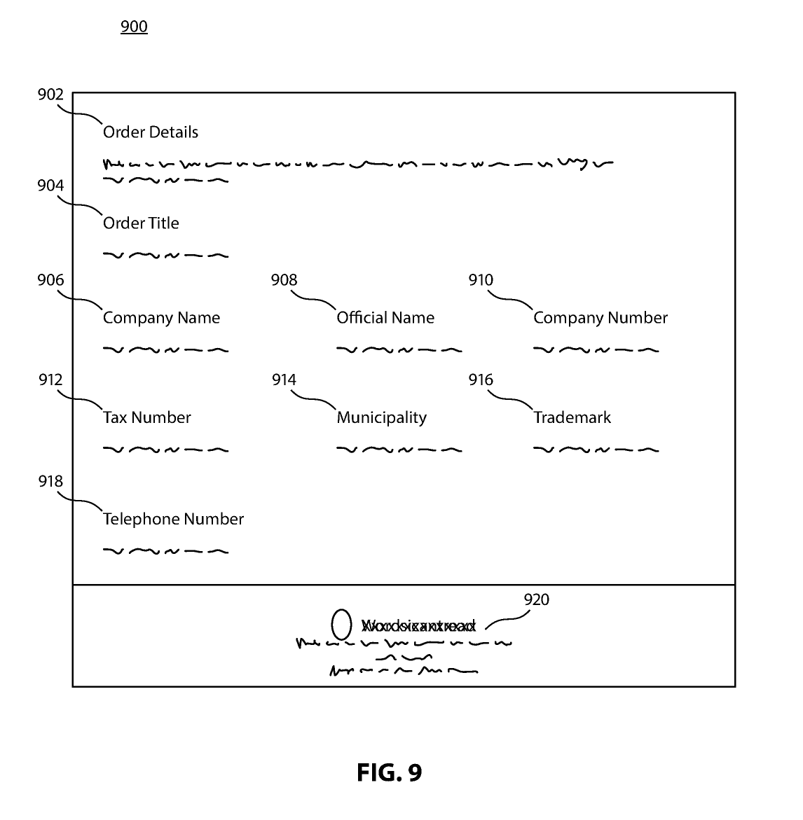

FIG. 9 illustrates an interface 900 showing an exemplary Order Details 902 page which may include the Order Title 904, Company Name 906, Official Name 908, Company Number 910, Tax Number 912, Municipality 914, Trademark 916, and Telephone Number 918, for example. Other data may be shown in the spirit and scope of the disclosed invention. Additional data 920 may also be provided.

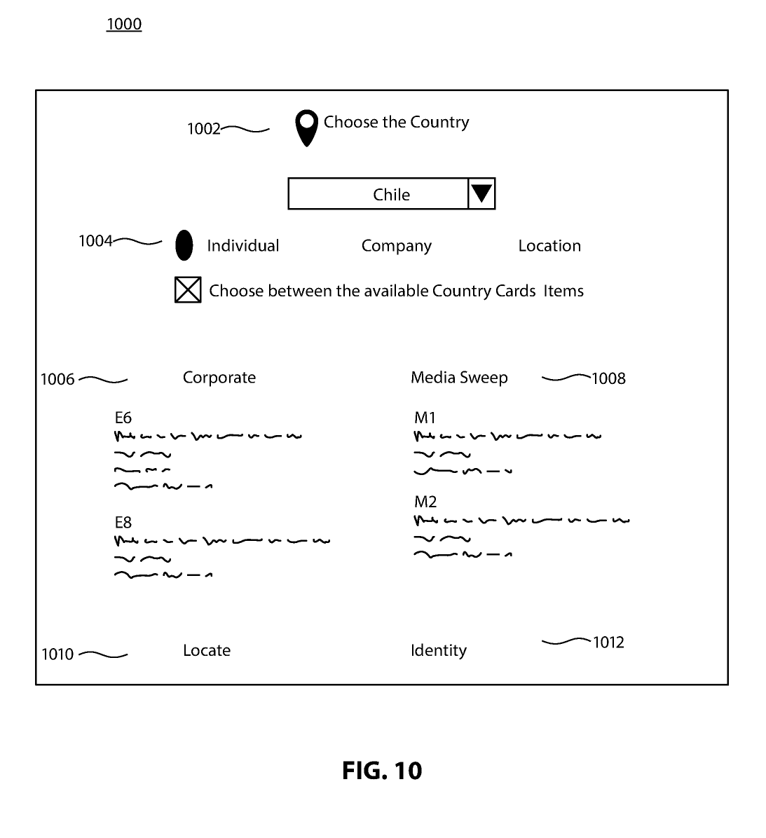

FIG. 10 illustrates an interface 1000 when chosen country 1002 and individual 1004 have been selected. Available data for the country card for an individual may provide differing information, for example Corporate 1006 and Media Sweep 1008. Additional buttons may be provided for user selection, Locate 1010 and Identity 1012.

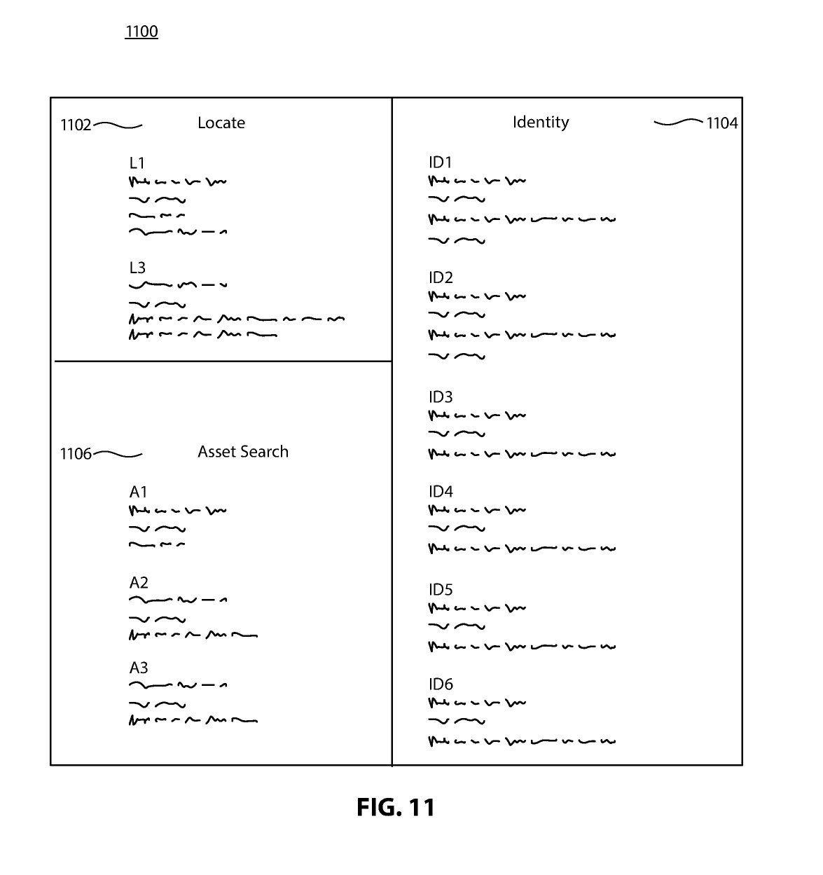

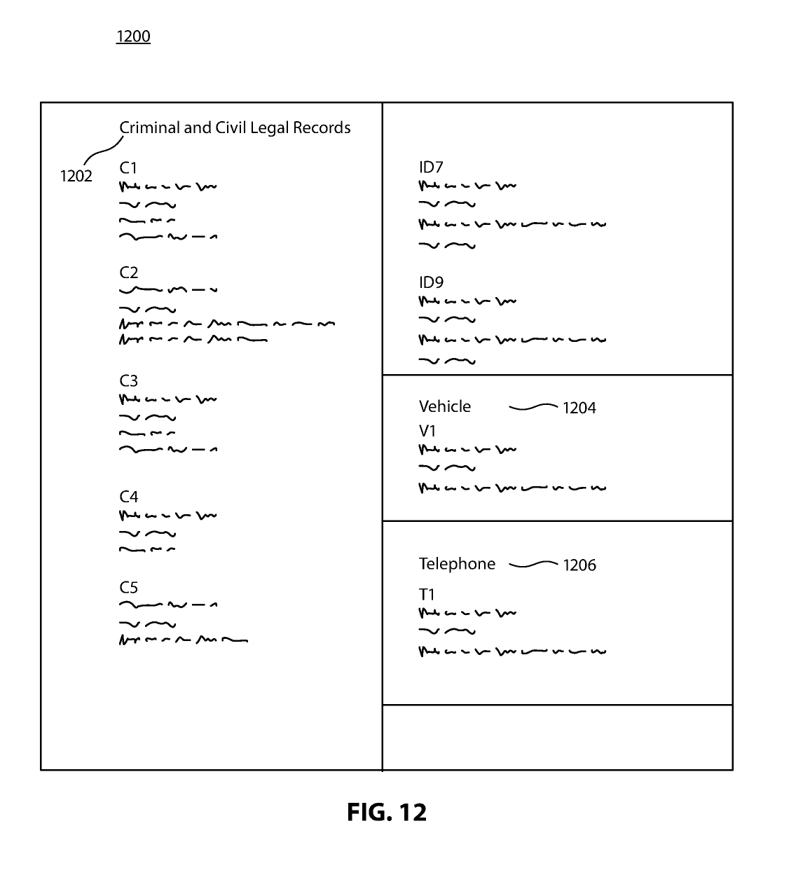

FIG. 11 illustrates an interface 1100 where a user may be shown additional, or more detailed information, with respect to Location 1102, Asset Search 1106, and Identity information 1104. FIG. 12 illustrates an interface 1200 where a user may be shown additional, or more detailed information, with respect to Criminal and Civil Legal Records 1202, Vehicle information 1204, and Telephone information 1206.

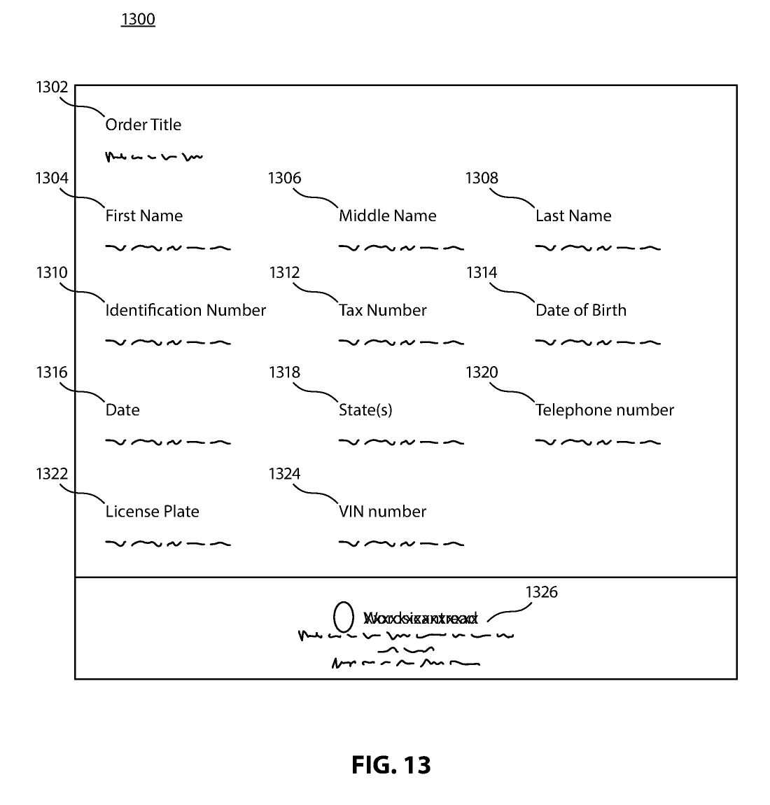

FIG. 13 illustrates an exemplary interface 1300 that may be shown to a user including a plurality of fields. The plurality of fields may include, for example, Order Title 1302, First Name 1304, Middle Name 1306, Last Name 1308, Identification number 1310, Tax Number 1312, Date of Birth 1314, Date 1316, State(s) 1318, Telephone Number 1320, License Plate 1322, and VIN number 1324. Additional information may be provided, as needed, in box 1326.

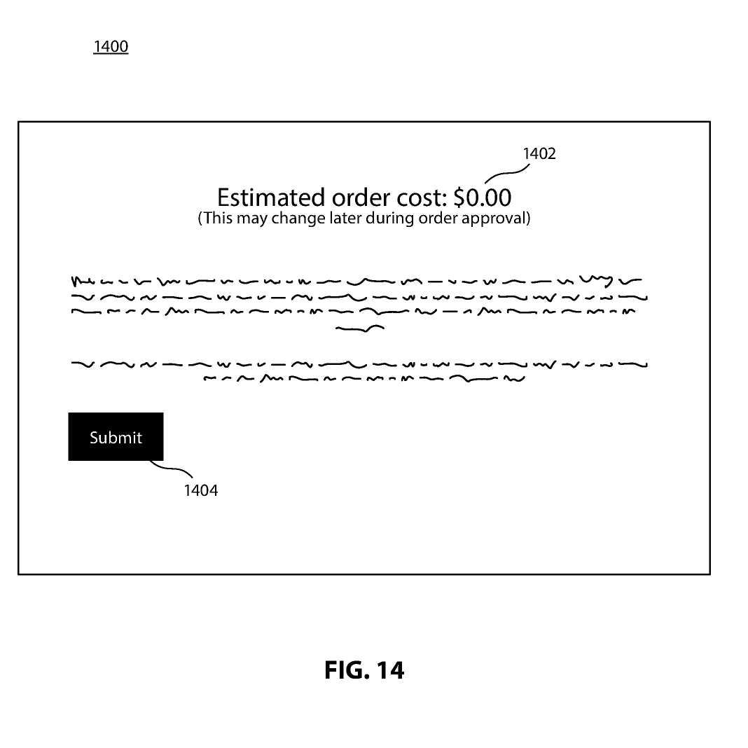

After the order has been set up by a client via the platform, the client may be shown interface 1400 of FIG. 14. The client may be shown an estimated order cost 1402 along with various agreement language. In order to submit the order, the client may simply select button 1404.

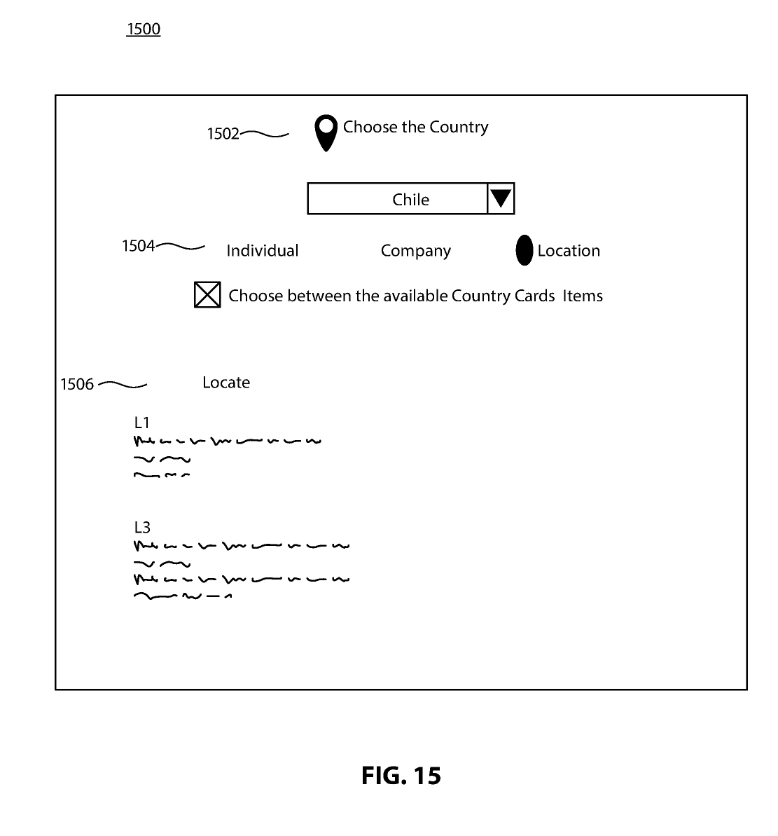

FIG. 15 illustrates an interface 1500 when chosen country 1502 and Location 1504 have been selected. Available data for the country card for a location may provide differing information, for example Locate 1506.

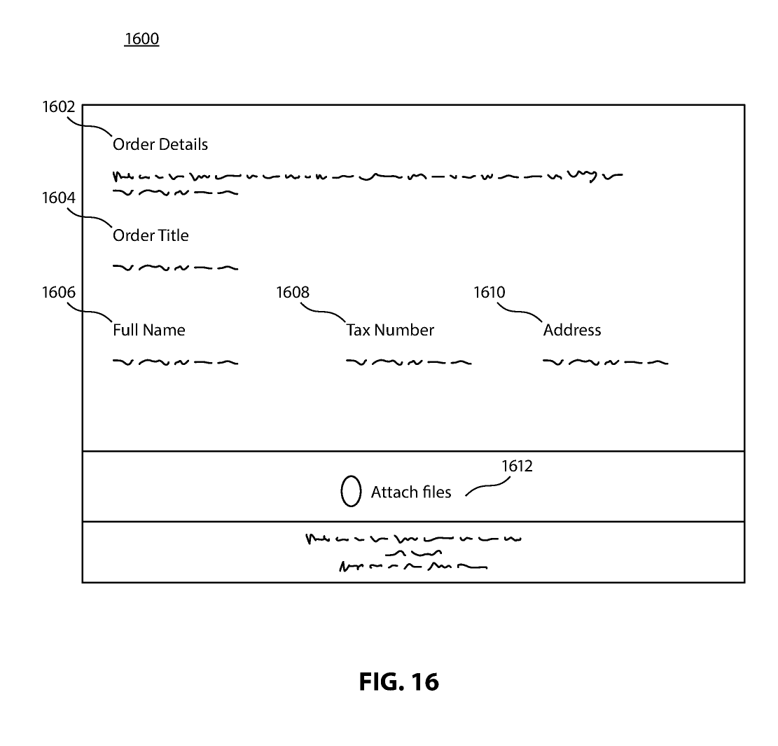

FIG. 16 illustrates an interface 1600 showing an exemplary Order Details 1602 page which may include the Order Title 1604, Full Name 1606, Tax Number 1608, and Address 1610, for example. Requisite files may be attached in box 1612.

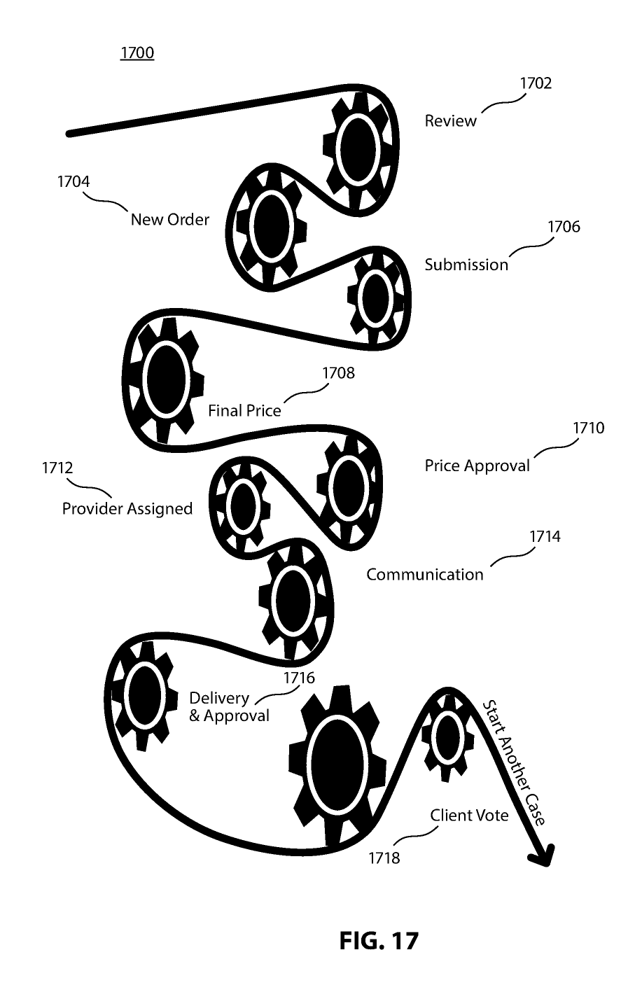

FIG. 17 provides an exemplary workflow diagram 1900 process of the disclosed invention by a server platform. In step 1702, a user may review country cards and select a country card to order items from. In step 1704, the user may create a new order and provide specific order details. Additional data may be provided, such as file attachments, for example. In step 1906, the user may submit the order for processing by the server platform. In step 1908, a final price may be determined by the server platform and approved by the user in step 1910. At step 1912, the local provider, such as of a foreign jurisdiction described herein and above, may be assigned and secure anonymous communication 1914 may be facilitated between the user and provider. In step 1916, the provider may deliver to the platform documents as-requested by the order details for approval by an admin of the platform server, the user, or both. Once approved, in step 1918, the client may vote to have the order archived and therefore closed.

In at least one exemplary embodiment, suppliers may be cleared for compliance by one or more agents associated with the server platform. For example, suppliers may be vetted by an internal team of agents. Suppliers may be vetted through a process comprising one more steps including: recruitment, on boarding/compliance, payment process established/third-party ID and location verification, text cases, and go live, for example. The compliance process may include basic information collection (e.g., Identification, contact information, C.V., etc.). The basic information may also include an individual questionnaire including further explanation and signature acceptance. The signature acceptance may include signature compliance in accordance with certain laws and regulations, for example FCP and UK anti-bribery law.

Clients, or users of the server platform, may also be vetted by the same or different internal team of agents of the server platform. For example, the clients may be vetted by a sales team of agents of the server platform. Clients may arrive to the server platform via a web page or site of the server platform. Prospective clients may be subject to a background check using public data, such as an inspection of professional social network accounts (e.g., LinkedIn®). Prospective clients are only added to the server platform once it is determined that the clients have a demonstrable interest in using the platform for professional reasons.

City/Country cards may be composed of a plurality of items including, but not limited to:
Title—Request definition (i.e. Company Registration Records (Copies of Official Documents))
Code Unique SKU for each item
Cost—The price that the client will pay
Commission—The commission that the platform will pay to the provider
TAT—Turn Around Time for delivery (in working days)
Description—detailed description of the task
Requirements—Every initial mandatory information for the task

Associative Information—Locations

Countries:
Name—Name of the Country
Code—Two letters ISO code
Flag—Flag of the Country
Status—Active/Inactive

Cities:
Name—Name of the City
Country—Related Country
Status—Active/Inactive

Categories
Grouping City Card Items (corporate, reputation, locate, etc.)

User Accounts

Account Types:
Administrator (full access to platform system)
Network Manager
Account Managers (access to manage invoice module)
Order Managers (Multi-Country Associated) (access to manage orders and users/providers; access orders from multiple countries associated therewith; access to manage support cases)
Providers (access to open orders on the allowed areas; access to orders assigned to them; access to submit supports cases; access to invoice module)
Users (clients) (Access to submit orders; access to their own orders; access to submit support cases; access to invoice module)

Implementation Examples

Case 1: Case Data Analytics Firm

A client, or demander, may be part of a data analytics firm focused on the financial services sector. The firm may offer a service that meets the needs banks and financial service firms have to reduce their exposure to bad actors. The firm may help banks identify beneficial ownership of questionable account holders, and then rate these individuals and/or companies in relation to known bad actors. Beneficial ownership information may be an important need to know piece of data for the firm and its clients. Beneficial ownership may be specifically the individual who is listed as a shareholder in any given company or enterprise. The firm may retain services to collect corporate registration documents, which may reveal shareholder information, in those jurisdictions where the documents are known to be available only offline. Database maintenance may also be achieved in the instance where corporate data records may have a short shelf life (3 months, for example).

Case 2: Global Textile Manufacturing Firm

Another exemplary client may he a global textile manufacturing company. Production may be centralized in a foreign country, such as Honduras. An individual background check may be required for each employed, or prospectively employed, individual. The company may retain services to complete its entire load of criminal background checks for Honduras, translating to thousands of background checks a year. As data, these background checks may include police records that may show either a clean background or proof of prior arrests and/or convictions. The central server as described herein and above may enable the company to quickly expand its offering of background checks in all of the markets where the company operates, such as Mexico, Nicaragua, Costa Rica, Dominican Republic, Haiti, and Bangladesh, for example.

Case 3: Big Four Accounting

Another exemplary client may be a large accounting firm and assigned to a so-called global master service agreement. The large accounting firm may have offices across the United States. Associates, managers, directors, and managing directors, for example, of the firm may leverage the central server and platform to collect information relevant to the needs of their own projects in asset tracking, due diligences, supply chain remediation, or other professional services, for example. Project data needs may range from corporate registration and criminal litigation records, to site visits and address verification, where the deliverable is not a document but a photograph. The firm may utilize the platform to fill gaps where internal teams of the firm do not have the network to obtain locally sourced offline records.

Case 4: Online Database of Global Records

A collection of companies may utilize the disclosed platform to collect critical business information. The collection of critical business information may create what is called a “database of databases.” Web crawlers may be utilized to ceaselessly update the database with all the information available online as it relates to corporate registration information, worldwide. In markets where no online database exists, or where an online database is not complete or of low fidelity, the collection of companies may rely on the disclosed platform to provide the incomplete information. The platform may perform manual checks of certain jurisdictions to provide the incomplete information. Data for the client may include corporate registration documents and other information related thereto, for example.

Those of skill in the art will appreciate that the herein described apparatuses, engines, devices, systems and methods are susceptible to various modifications and alternative constructions. There is no intention to limit the scope of the invention to the specific constructions described herein. Rather, the herein described systems and methods are intended to cover all modifications, alternative constructions, and equivalents falling within the scope and spirit of the disclosure, any appended claims and any equivalents thereto.

In the foregoing detailed description, it may be that various features are grouped together in individual embodiments for the purpose of brevity in the disclosure. This method of disclosure is not to be interpreted as reflecting an intention that any subsequently claimed embodiments require more features than are expressly recited.

Further, the descriptions of the disclosure are provided to enable any person skilled in the art to make or use the disclosed embodiments. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but rather is to be accorded the widest scope consistent with the principles and novel features disclosed herein.

I claim:

1. A secure anonymous messaging system for data acquisition between at least two computing devices, the system comprising:
at least one server comprising a memory and at least one hardware processor;
a database communicatively coupled to the at least one server;
at least one card stored on the database;
at least one requester; and
at least one provider;
wherein the at least one server facilitates messaging between the at least one requester and the at least one provider.

2. The messaging system of claim 1, wherein the messaging is done anonymously.

3. The messaging system of claim 1, wherein the requester posts an order to the at least one server based on one or more pieces of information on the card.

4. The messaging system of claim 3, wherein the order is queued by the at least one server.

5. The messaging system of claim 4, wherein an admin acts on the queued order by:
approving a conversation between the at least one requester and the at least one provider;
determining what data will be made available during the conversation between the at least one requester and the at least one provider;
ordering cost and commission;
approving order and attachments; and
assigning the order to the at least one provider.

6. The messaging system of claim 5, further comprising:
receiving acceptance of the order assignment by the at least one provider; and
in response to acceptance, entering the at least one provider into the conversation.

7. The messaging system of claim 6, further comprising:
receiving findings from the at least provider based on the order;

8. The messaging system of claim 7, further comprising:
sending the findings to the at least one requester; and
receiving acceptance of the findings from the at least one requester.

9. The messaging system of claim 8, wherein the at least one requester accepts the findings by voting.

10. The messaging system of claim 9, wherein the order is archived in response to a vote received from the admin.

11. A secure anonymous messaging platform for data acquisition between at least two computing devices, comprising:
at least one server comprising a memory and at least one hardware processor;
a database communicatively coupled to the at least one server;
at least one city card stored on the database;
at least one requester; and
at least one provider;
wherein the at least one server facilitates messaging between the at least one requester and the at least one provider.

12. The messaging platform of claim 11, wherein the messaging is done anonymously.

13. The messaging platform of claim 11, wherein the requester posts an order to the at least one server based on one or more pieces of information on the city card.

14. The messaging platform of claim 13, wherein the order is queued by the at least one server.

15. The messaging platform of claim 14, wherein an admin acts on the queued order by:
approving a conversation between the at least one requester and the at least one provider;
determining what data will be made available during the conversation between the at least one requester and the at least one provider;
ordering cost and commission;
approving order and attachments; and
assigning the order to the at least one provider.

16. The messaging platform of claim 15, further comprising:
receiving acceptance of the order assignment by the at least one provider; and
in response to acceptance, entering the at least one provider into the conversation.

17. The messaging platform of claim 16, further comprising:
receiving findings from the at least provider based on the order;

18. The messaging platform of claim 17, further comprising:
sending the findings to the at least one requester; and
receiving acceptance of the findings from the at least one requester.

19. The messaging platform of claim 18, wherein the at least one requester accepts the findings by voting.

20. The messaging platform of claim 19, wherein the order is archived in response to a vote received from the admin.
